(19) United States
(12) Patent Application Publication
(10) Pub. No.: US 2007/0220098 A1
(43) Pub. Date: Sep. 20, 2007

(54) Method for exchanging messages between an email client and a unified messaging system

(75) Inventors: Tom Adams, Austin, TX (US); Yi Zhang, Austin, TX (US); Art Daddona, Austin, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/384,623

(22) Filed: Mar. 20, 2006

(51) Int. Cl. G06F 15/16

(52) U.S. Cl. 709/206

(57) ABSTRACT

An apparatus and method are disclosed for exchanging messages between an email client and a unified messaging system. An apparatus that incorporates teachings of the present disclosure may include, for example, a unified messaging system (UMS) (102) having a controller (108) that manages operations of a communications interface (104) that communicates with communication devices in a communication system (100). The controller can be programmed to receive (304) from an email client operating in a select one of the communication devices an identification, validate (308) the identification according to subscriber information in a directory, establish (312) a secure communications link with the email client upon validating the identification, identify (314) a message server from the subscriber information, authenticate (316) the email client at the message server, and enable (318) communications between the email client and the message server over the secure communications link. Additional embodiments are disclosed.

### FIELD OF THE DISCLOSURE

The present disclosure relates generally to unified messaging systems, and more specifically to a method for exchanging messages between an email client and a unified messaging system.

### BACKGROUND

Unified messaging systems (UMS) have been useful to end users who like to manage their email, faxes, landline and wireless voicemail services from a central location. Extending accessibility to such systems by way of email clients can pose a security risk to a UMS and correspondingly its end users.

### BRIEF DESCRIPTION OF THE DRAWINGS

FIG. 1 depicts an exemplary embodiment of communication devices communicating with a unified messaging system (UMS) by way of access points collectively operating in a communication system;

FIG. 2 depicts an exemplary block diagram of the communication device;

FIG. 3 depicts an exemplary method operating in portions of the UMS and an email client operating in the communication device; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for exchanging messages between an email client and a unified messaging system.

In a first embodiment of the present disclosure, a unified messaging system (UMS) can have a controller that manages operations of a communications interface that communicates with communication devices in a communication system. The controller can be programmed to receive from an email client operating in a select one of the communication devices an identification, validate the identification according to subscriber information in a directory, establish a secure communications link with the email client upon validating the identification, identify a message server from the subscriber information, authenticate the email client at the message server, and enable communications between the email client and the message server over the secure communications link.

In a second embodiment of the present disclosure, a computer-readable storage medium in a unified messaging system (UMS) can have computer instructions for establishing a secure communications link with an email client upon validating a credential supplied by the email client, and enabling communications between a message server and the email client over the secure communications link upon authenticating the email client with the message server.

In a third embodiment of the present disclosure, a computer-readable storage medium in a communication device can have computer instructions for transmitting an identification to a unified messaging system (UMS) associated with an email client operating in the communication device, establishing a secure communications link with the UMS upon a validation of the identification by the UMS, and enabling communications over the secure communications link with a message server of the UMS upon the UMS authenticating the email client with the message server according to its identification.

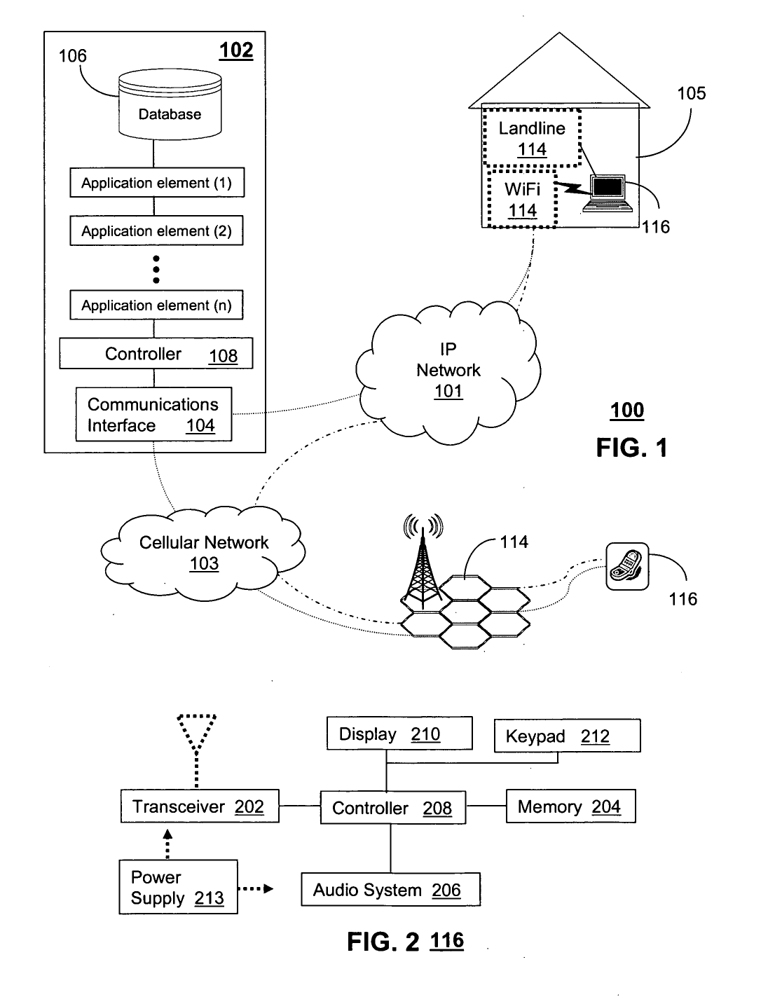

FIG. 1 depicts an exemplary embodiment of communication devices 116 communicating with a unified messaging system (UMS) 102 by way of access points (APs) 114 collectively operating in a communication system 100.

The communication device 116 can represent any common computing device (e.g., a landline phone, a cellular phone, or a landline or wireless laptop computer) capable of communicating with one or more APs 114 in the communication system 100. The APs 114 of FIG. 1 depict a number of possible embodiments including a plurality of cellular base stations supporting wireless voice and/or data communications in a cellular network 103, one or more Wireless Fidelity (WiFi) access points, and/or common landline services such as a plain old telephone service (POTS), ISDN, DSL, or Cable, just to mention a few, operating in a commercial enterprise or residence 105.

The cellular network 103 can utilize circuit-switched technology supporting voice and data services such as GSM-GPRS, EDGE, CDMA-1X, EV/DO, UMTS, and other known and next generation cellular communications technologies. The cellular network 103 is coupled to the APs 114 according to a frequency-reuse architecture for communicating over-the-air with roaming communication devices 116. WiFi access points can conform to any one of IEEE's 802.11 present and next generation protocols (e.g., IEEE 802.11 a, b, g, n and/or next generation technologies) and can operate individually or in a mesh network.

Alternatively, or in combination, other wireless access technologies can be applied to the present disclosure such as, for example, a Worldwide Interoperability for Microwave Access (WiMAX), ultra wide band (UWB), Bluetooth™, and software defined radio (SDR). SDR allows for accessibility to public and private communication spectrum with any number of communication protocols that can be dynamically downloaded over-the-air. Other present and future generation wireless access technologies can also be used in the present disclosure.

The communication system 100 can further comprise an IP (Internet Protocol) network 101 that couples the UMS 102 to the APs 114 for carrying Internet traffic therebetween. The UMS 102 comprises a communications interface 104 utilizing common technology for communicating over an IP interface with the IP network 101, and with the cellular network 103 by conventional communication lines or the IP network 101. By way of the communications interface 104, the UMS 102 can exchange messages with the communication devices 116 in any location convenient for the end user of said devices.

The UMS 102 can utilize a memory 106 (such as a high capacity storage medium) embodied in this illustration as a database, and a controller 108 having computing technology such as a desktop computer, or scalable server for managing the database 106 and for controlling a number of applications and/or servers operating in the UMS 102. These applications or servers may include, for example, a remote authentication dial-in user service (RADIUS) server, a secure socket layer (SSL) gateway, a subscriber directory, one or more message servers, and a message transfer agent.

The RADIUS server implements an Authentication, Authorization and Accounting (AAA) protocol to provide access to the UMS 102 for local and roaming communication devices 116. The SSL gateway can establish secure inbound and outbound communications with the communication devices 116 with the SSL protocol. The subscriber directory can be an integral part of the database 106 for storing subscriber information for each of the communication devices 116. A message server can manage any number of message types (e.g., email, fax, landline and wireless voicemail messages) directed to an end user of a select one of the communication devices 116.

For a large number of communication devices 116, a number of corresponding message servers can be deployed in the UMS 102. Communication devices 116 can be transferred from one message server to another without disturbing services by updating the subscriber information in the subscriber directory to account for such changes. This can be especially beneficial for maintenance operations of the UMS 102. Depending on the email clients supported, message servers can operate according to any number of messaging protocols such as an Internet Message Access Protocol (IMAP), a post office protocol (POP), and a hyper text transfer protocol (HTTP). The message transfer agent can serve to forward messages submitted by the communication devices 116 to targeted third parties.

FIG. 2 is an exemplary block diagram of the communication device 116. In a first embodiment, the communication device 116 can utilize landline or short range transceiver technology 202 (such as in a cordless phone) to support mobility within a small area such as the end user's residence or enterprise according to any of the aforementioned access technologies. Alternatively, the communication device 116 can represent a mobile device utilizing a wireless transceiver 202 that supports mid to long-range wireless communications with the APs 114 for exchanging voice and data messages with other targeted mobile devices or the UMS 102 within the bounds of the communication system 100.

Combinations of these embodiments can also be used to form a multimode communication device (MCD). That is, when the MCD is within the premises of the building 105 it can function as a POTS, ISDN, DSL, WiFi, or Bluetooth™ device. When roaming outside the building 105, the MCD can function as a wireless communication device operating in the cellular network 103. In any of these embodiments, the communication device can utilize circuit-switched or packet switched communications, thereby supporting data communications and traditional voice or voice over IP (VoIP) communications.

Each of the foregoing embodiments of communication devices 116 can utilize a memory 204, an audio system 206, and a controller 208 among other possible functional components. The memory 204 can comprise storage devices such as RAM, SRAM, DRAM, and/or Flash memories. The memory 204 can be external or an integral component of the controller 208. The audio system 206 can be utilized for exchanging audible signals with an end user. The communication device 116 can further include a display 210 for conveying images to the end user, a keypad 212 for manipulating operations of the communication device 116, and a portable power supply 213. The audio system 206, the display 210, and the keypad 212 can singly or in combination represent a user interface (ULI) for controlling operations of the communication device 116 as directed by the end user. The controller 208 can manage the foregoing components with computing technology such as a microprocessor and/or digital signal processor.

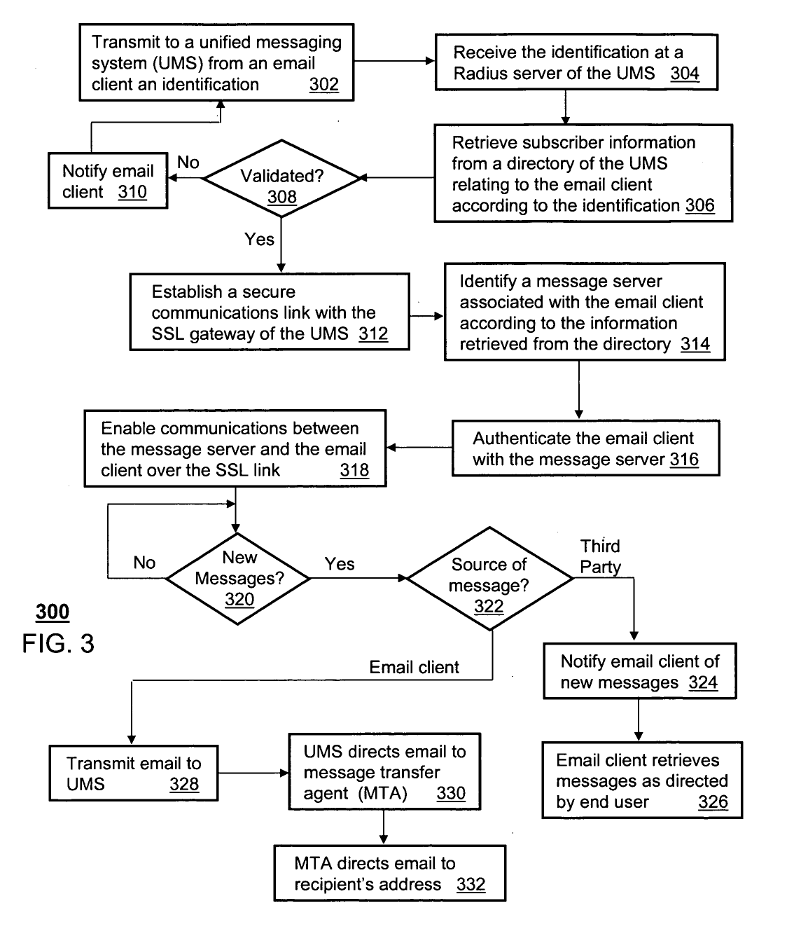

FIG. 3 depicts an exemplary method 300 operating in portions of the UMS 102 and the communication devices 116. Method 300 illustrates embodiments in which the communication device 116 can exchange a number of message types with the UMS 102. Method 300 begins with step 302 in which an email client operating in a select one of the communication devices 116 transmits an identification to the UMS 102 to establish communications with an associated message server. The email client can be any common email client such as, for example, Microsoft Outlook™, Lotus Notes™, Qualcomm's Eudora™, or any other suitable email client that can be applied to the present disclosure. The RADIUS server receives the identification in step 304 and begins the authentication process by retrieving in step 306 subscriber information from the subscriber directory according to the identification supplied by the communication device 116. The identification can represent singly or in combination a user name, a password, a personal identification number (PIN), or a portion of an email address (e.g., a domain name) associated with the email client.

In step 308, the RADIUS server determines by common means whether the identification supplied is authorized for access to services of the UMS 102. If it is not, the UMS 102 can be programmed in step 310 to notify the email client of the failed attempt. Although not shown, the UMS 102 can be programmed for security purposes to limit the number of additional authentication attempts made by the end user operating the email client. If, on the other hand, identification supplied is validated by the RADIUS server, the UMS 102 can be programmed to call on the SSL gateway in step 312 to establish a secure communications link between the email client and the UMS 102 with the SSL protocol. While this is occurring, the UMS 102 can be programmed in step 314 to concurrently identify a message server associated with the email client according to the subscriber information retrieved from the directory.

Once the message server is identified, the UMS 102 can be programmed to authenticate the email client with the message server with the same identification provided earlier in step 304, or with other forms of identification included in the subscriber information retrieved in step 306. This step avoids the end user operating the email client to have to authenticate him/herself twice (once with the RADIUS server, and another time with the message server). Once authenticated, the UMS 102 can be programmed to enable communications in step 318 between the message server and the email client over the SSL link. From this point on, the email client and the UMS 102 can exchange messages.

For example, in step 320, the UMS 102 can be programmed to identify new messages sourced by the email client or the UMS 102. If a new message is detected, in step 322 the UMS 102 is directed to steps 324-326 if the message is an unread message received from a third party. In this case, the UMS 102 notifies the email client in step 324 of the new message, and in step 326 the email client retrieves the message by conventional means. These exchanges as noted earlier take place over a secure SSL communications link.

If instead the email client has generated a new message directed to a third party, the email client proceeds to step 328 where it transmits the message to the UMS 102. In step 330, the UMS 102 directs the email to the message transfer agent (MTA) which in turn directs in step 332 the email to the recipient email address included in the simple mail transfer protocol (SMTP) header of the email message supplied by the email client. Steps 328-332 can result from the end user of the email client forward, replying or drafting new messages for a third party. Given the messaging capabilities of the UMS 102, the new message generated by the email client can be represented by a text email, a fax, or voicemail.

The present disclosure overcomes the deficiencies in the prior art by providing an end user a means to securely access email, faxes, landline and wireless voicemails. It would be evident to an artisan with ordinary skill in the art that the foregoing embodiments illustrated by method 300 can be modified, reduced, or enhanced without departing from the scope and spirit of the claims described below. The reader is therefore directed to the claims for the fullest understanding of the breadth and scope of the present disclosure.

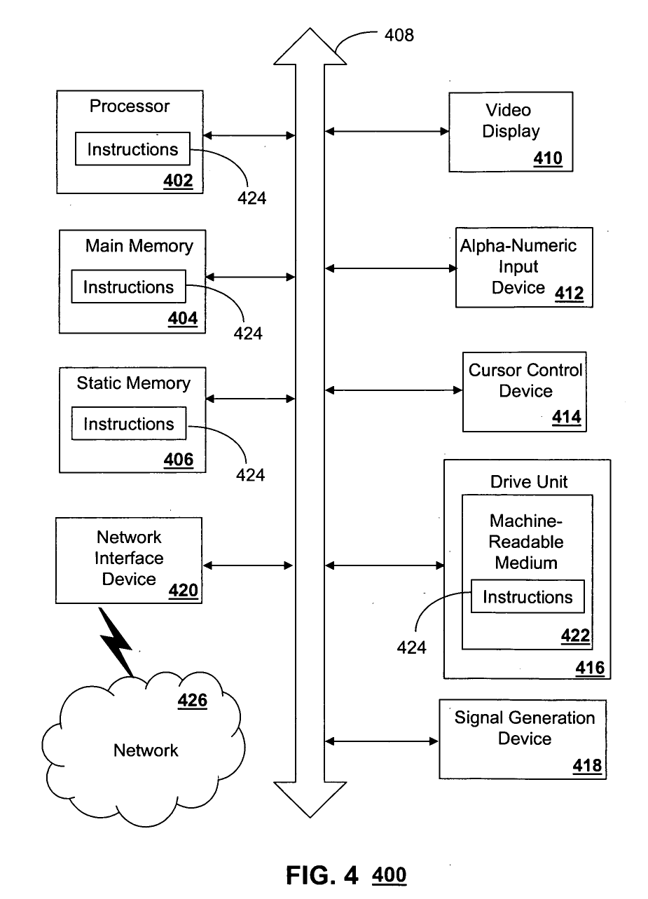

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A unified messaging system (UMS), comprising:
a controller that manages operations of a communications interface that communicates with communication devices in a communication system, wherein the controller is programmed to:
receive from an email client operating in a select one of the communication devices an identification;
validate the identification according to subscriber information in a directory;
establish a secure communications link with the email client upon validating the identification;
identify a message server from the subscriber information;
authenticate the email client at the message server; and
enable communications between the email client and the message server over the secure communications link.

2. The UMS of claim 1, wherein the controller is programmed to establish the secure communications link according to a secure socket layer (SSL) protocol.

3. The UMS of claim 1, wherein the message server operates in conformance to Internet Message Access Protocol (IMAP), and wherein the controller is programmed to exchange messages with the message server according to IMAP.

4. The UMS of claim 1, wherein the message server comprises one among a post office protocol (POP) server, an exchange server, and a hyper text transfer protocol (HTTP) server.

5. The UMS of claim 1, wherein the controller is programmed to utilize a remote authentication dial-in user service (RADIUS) protocol for verifying the identification supplied by the email client.

6. The UMS of claim 1, wherein the identification comprises at least one among a user name, a password, a personal identification number, and a portion of an email address associated with the email client.

7. The UMS of claim 1, wherein the message server manages at least one among a group of message types comprising an email message, a fax message, a wireless voicemail message, and a landline voicemail message.

8. The UMS of claim 7, wherein the controller is programmed to:
receive at least one among the group of message types from a third party; and
transmit to the email client a notice identifying the at least one message type received from the third party.

9. A computer-readable storage medium in a unified messaging system (UMS), comprising computer instructions for:
establishing a secure communications link with an email client upon validating a credential supplied by the email client; and
enabling communications between a message server of the UMS and the email client over the secure communications link upon authenticating the email client with the message server.

10. The storage medium of claim 9, comprising computer instructions for establishing the secure communications link according to a secure socket layer (SSL) protocol.

11. The storage medium of claim 9, comprising computer instructions for exchanging messages with the message server according to an Internet Message Access Protocol (IMAP).

12. The storage medium of claim 9, comprising computer instructions for exchanging messages with the message server according to one among a post office protocol (POP), and a hyper text transfer protocol (HTTP).

13. The storage medium of claim 9, computer instructions for verifying the credential of the email client according to a remote authentication dial-in user service (RADIUS) protocol.

14. The storage medium of claim 13, wherein the credential comprises at least one among a user name, a password, a personal identification number, and a portion of an email address associated with the email client.

15. The storage medium of claim 9, comprising computer instructions for:
receiving from a third party at least one among a group of message types comprising an email message, a fax message, a wireless voicemail message, and a landline voicemail message;
storing in the message server the at least one message type received; and
transmitting to the email client a notice identifying the at least one message type received from the third party.

16. A computer-readable storage medium in a communication device, comprising computer instructions for:
transmitting an identification to a unified messaging system (UMS) associated with an email client operating in the communication device;
establishing a secure communications link with the UMS upon a validation of the identification by the UMS; and
enabling communications over the secure communications link with a message server of the UMS upon the UMS authenticating the email client with the message server according to its identification.

17. The storage medium of claim 16, comprising computer instructions for:
constructing an email message directed to a target party's account in the UMS;
populating a “To” field of an simple mail transfer protocol (SMTP) header of the email message with a recipient email address associated with the target party;
populating a “From” field of the SMTP header of the email message with a sender's email address associated with the email client;
transmitting the email message to the UMS over the secure communications link.

18. The storage medium of claim 17, wherein the UMS directs the email message to a message transfer agent which forwards the email to the target party according to the recipient email address.

19. The storage medium of claim 16, wherein the identification comprises at least one among a user name, a password, a personal identification number, and a portion of an email address associated with the email client.

20. The storage medium of claim 16, comprising computer instructions for processing at least one among an email message, a fax message, a wireless voicemail message, and a landline voicemail message managed by the message server of the UMS.
